(19) United States
(12) Patent Application Publication
(10) Pub. No.: US 2005/0057707 A1
(43) Pub. Date: Mar. 17, 2005

(54) Super white cholesteric display employing backside circular polarizer

(76) Inventor: Yao-Dong Ma, Frisco, TX (US)

Correspondence Address: Yao-Dong Ma, 14586 Pensham Dr., Frisco, TX, 75035, US

(21) Appl. No.: 10/664,990

(22) Filed: Sep. 17, 2003

(51) Int. Cl. G02F 1/1335

(52) U.S. Cl. 349/98

(57) ABSTRACT

The present invention relates to cholesteric displays, more specifically, to reflective cholesteric displays employing a backside circular polarizer. In the paper white mode, the bright white state is achieved in display's focal conic texture area; and the dark color state is obtained in display's planar texture area. In the full color mode, meanwhile, the full color state is created in the focal conic texture area; and the dark color state is achieved in the cholesteric focal conic texture area. Either the absorptive circular polarizer or the reflective broadband circular polarizer can be used as the backside polarizer. A bright neutral white color with 50% front light reflection has been accomplished in the novel display.

### FIELD OF INVENTION

The present invention relates to cholesteric displays, more specifically, to reflective cholesteric displays employing a backside circular polarizer. In the paper white mode, the bright white state is achieved in display's focal conic texture area; and the dark color state is obtained in display's planar texture area. In the full color mode, meanwhile, the full color state is created in the focal conic texture area; and the dark color state is achieved in the cholesteric focal conic texture area. Either the absorptive circular polarizer or the reflective broadband circular polarizer can be used as the backside polarizer. A bright neutral white color with 50% front light reflection has been accomplished in the novel display.

### BACKGROUND OF THE INVENTION

Cholesteric liquid crystal displays are characterized by the fact that the pictures stay on the display even if the driving voltage is disconnected. The bistability and multistability not only ensure a completely flicker-free static display but also have the possibility of infinite multiplexing to create giant displays and/or ultra-high resolution displays. In cholesteric liquid crystals, the molecules are oriented in helices with a periodicity characteristic of material. In the planar state, the axis of this helix is perpendicular to the display plane. Light with a wavelength matching the pitch of the helix is reflected and the display appears bright. If an AC-voltage is applied, the structure of the liquid crystals changes from planar to focal conic texture. The focal conic state is predominately characterized by its highly diffused light scattering appearance caused by an abrupt change of the refractive indices at the boundary between cholesteric domains. This texture has no single optic axis. The focal conic texture is typically milky-white (i.e. white light scattering). Both planar texture and focal conic texture can coexist in the same panel or entity. This is a very important property for display applications, whereby the gray scale can be realized.

Current cholesterics displays are utilizing “Bragg reflection”, one of the intrinsic properties of cholesterics. In Bragg reflection, only a portion of the incident light with the same handedness of circular polarization and also within the specific wave band can reflect back to the viewer, which generates a monochrome display. The remaining spectrum of the incoming light, however, including the 50% opposite handedness circular polarized and the out of Bragg reflection wave band, will pass through the display and be absorbed by the black coating material on the back surface of the display to ensure the contrast ratio. The overall light utilization efficiency is rather low and it is not qualified in some applications, such as a billboard at normal ambient lighting condition. The Bragg type reflection gives an impression that monochrome display is one of the distinctive properties of the ChLCD.

In many applications, human eyes are friendlier with full color spectrum, i.e. white color information written on the dark background. With the development of the flat panel display, more and more displays with neutral color have come into being, such as black-and-white STN display and AMTFT display, etc. Unfortunately, both of these approaches involve major disadvantages and limitations. The AMTFT displays are not true zero field image storage systems because they require constant power input for image refreshing. The STN displays do not possess inherent gray scale capability as a result of the extreme steepness of the electro-optical response curve of the display. To realize a gray scale, the resolution has to be reduced by using, for example, four pixels instead of one per area. Anywhere from one to four pixels are activated at a particular time to provide the gray scale effect. The AMTFT devices use semiconductors to provide memory effects and involve the use of expensive, ultra high resistance liquid crystal materials to minimize RC losses. The cholesteric display has many advantages over the STN and AMTFT display with its zero field memory effect, hemispheric viewing angle, gray scale capability and other optical performances, but it obviously needs to come up with pure white reflection instead of the narrow band Bragg reflection to keep its superiority.

U.S. Pat. No. 5,493,430 introduces a way to attach a color plate to the back substrate of the display instead of a black one to achieve white on blue, white on yellow or “white on color” mode display. For example, a bluish white color appears on the planar texture pixels and the blue color appears on the focal conic texture pixels. The white color is derived from the pre-selected color of the Bragg reflection combined with the bluish background color. However the white color is only displayed in the normal angle and it exists a color shift when being viewed at an oblique angle. Furthermore, the display has a relatively low contrast ratio.

U.S. Pat. No. 5,796,454 introduces a black-and-white back-lit ChLC display. It includes controllable ChLC structure, the first circular polarizer laminating to the first substrate of the cell which has the same circular polarity as the liquid crystals, the second circular polarizer laminating to the second substrate of the cell which has a circular polarity opposite to the liquid crystals, and a light source. The display is preferably illuminated by a light source that produces natural “white” light. Thus, when the display is illuminated by the back light, the circular polarizer transmits the 50% component of the incident light that is right-circularly polarized. When the ChLC is in an ON state, the light reflected by the ChLC is that portion of the incident light having wavelengths within the intrinsic spectral bandwidth, and the same handedness; The light that is transmitted through the ChLC is the complement of the intrinsic color of ChLC. Since the transmitted light has right-circular polarization, it will be blocked by the left-circular polarizer. Therefore, this area will be substantially black. When the display is in an OFF state, the light transmitted through the polarizer is optically scattered by the ChLC in focal conic structure. The portion of the incident light that is forward-scattered is emitted from the controllable ChLC structure as depolarized light. The left-circularly polarized portion of the forward-scattered light is then transmitted through the left-circular polarizer, and finally is perceived by an observer. Such black-and-white effect is achieved by the back-lit component and the ambient light is nothing but noise.

U.S. Pat. No. 6,344,887 introduces a method of manufacturing a full spectrum reflective cholesteric display, herein is incorporated by reference. '887 teaches a cholesteric display employing absorptive polarizers with the same polarity but different disposition. The display utilizes an absorptive circular polarizer and a metal reflector film positioned on the backside of the display to guide the second component of the incoming light back to the viewer. However, the shortcoming of the Iodine type absorptive polarizer makes the display to take on a tint of color in the optical ON state, for example, greenish white. The reasons for that are described as follows: Firstly, all the absorptive iodine polarizer has a more or less blue leaking problem which causes non-neutral color of a display device. Secondly, the absorptive polarizer has limited transmission (44%) and polarizing efficiency that causes the second reflection having less intensity than that of the first one. Thirdly, the metal reflector always has a limited reflectivity. Take the Aluminum for example, the reflectivity is in the range of 80˜90%. Fourthly, the quarter waveform retardation film can only match a narrow wavelength of the light to generate a circularly polarized light. Addition to the multi-layer surface mismatching, the total reflection of the back absorptive circular polarizer is around 35%. All those reasons result in a full spectrum cholesteric display appearing non-paper white.

### SUMMARY OF THE INVENTION

It is the primary objective of the present invention to realize a super white reflection in display's focal conic texture.

It is another objective of the present invention to create an optical dark state in display's planar texture.

It is still another objective of the present invention to use the Bragg reflection as the first color state.

It is also another objective of the present invention to use the complementary color of the Bragg reflection as the second color state.

It is again another objective of the present invention to take the advantage of the back scattering light of the focal conic texture to obtain the maximum brightness of the display.

It is furthermore another objective of the present invention to use a backside absorptive circular polarizer combined with a metal reflector.

It is still another objective of the present invention to utilize a specula reflective cholesteric polarizer to reflect the full spectrum incoming light in the focal conic texture and transmit most of the incoming light in the planar texture.

It is also another objective of the present invention to accomplish a neutral white front reflection over a hemispheric viewing angle.

It is again another objective of the present invention to create a reflective full color display by means of the micro color filter structure.

It is still another objective of the present invention to avoid using the Bragg reflection as an optical state.

It is furthermore another objective of the present invention to design a display cell structure with at least the front inner surface rubbed to generate a substantially single domain Bragg reflection, i.e., a mirror reflection.

### BRIEF DESCRIPTION OF THE DRAWINGS

FIG. 1 shows a schematic display structure of an absorptive circular polarizer, attached onto the back of the display cell, combined with a metal reflector.

FIG. 2 shows a schematic display structure of a specula reflective circular polarizer, attached onto the outside of the back substrate of the display cell, combined with a black painting layer.

FIG. 3 shows a schematic display structure of a specula reflective circular polarizer, attached onto the inside of the back substrate of the display cell, combined with an outside black painting layer.

FIG. 4 shows a schematic display structure of a front color filter deposited inside of the front substrate of the display cell.

FIG. 5 shows a schematic display structure of a back color filter deposited inside of the back substrate of the display cell.

### DETAILED DESCRIPTION

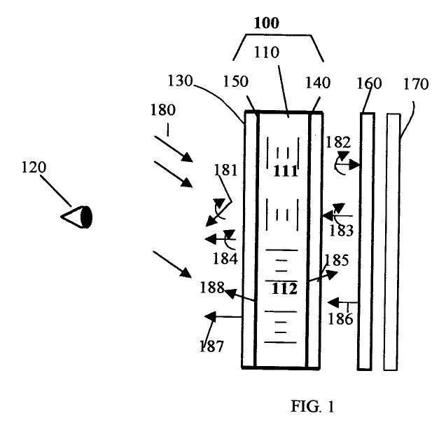

Referring first to FIG. 1, illustrated is a front-lit color-and-white cholesteric display structure. A cell structure 100 includes a cholesteric liquid crystal material 110, a front substrate 130 and a back substrate 140 and a polymeric ring material. The cell gap is controlled by a micro-beats with the diameter normally in the range of 2˜6 μm, most preferably, 3 μm. The front substrate and the back substrate are pre-coated a transparent thin film of conductive electrodes and a polyimide alignment layer on the inner surface, respectively. There are two cholesteric textures inside the cell structure: planar texture area 111 and focal conic texture area 112. Both are electrically controllable. There is a special single domain design in the present invention. The front alignment layer 150 has been rubbed to generate a substantially single domain structure in the cholesteric planar area while the back alignment can be either rubbed or non-rubbed. It is well known that the single domain planar texture has a mirror Bragg reflection. The cell structure combined with a back absorptive circular polarizer 160 and a metal layer 170 to form a complete display panel. The back circular polarizer 160 is made of a linear absorptive polarizer and a quarter wave retarder at a 45-degree lamination. The retarder is physically attached to the back substrate 140 and the metal layer 170 is attached on the linear polarizer side. The handedness of the circular polarizer is designed to be the same as the helical structure of the cholesteric liquid crystal, for example, right-hand for the convenience of description.

When the natural light 180 reaches the cholesteric liquid crystal 110 in planar texture area 111 through the front substrate 130, part of it (right-handed and within the Bragg wave band) will be mirror reflected (see light 181). The rest of it, including left-handed component and the remaining right-handed portion (see light 182) will hit on the back circular polarizer 160 through the area 111. The left-handed circular polarizing light will be filtrated by the right circular polarizer 160. Only the remaining right-handed circular polarizing light 183 has a chance to be reflected by the metal reflector. One may notice that the light 183 is a complementary color of 181. For example, if the Bragg reflection 181 is yellow, the light 183 will be blue. Furthermore, the light 183 passes the planer area 111, and finally emerges to the display front surface as the right-handed circular polarization 184.

There are two different appearances to the front viewer 120 in the display planar area depending on the emergent direction and distribution of the light 183, which is determined by the pattern of the metal reflector 170.

If the metal has a diffusive surface, it will reflect the light in a large distribution angle. The complementary color 183 will pass through the display cell and becomes a diffusive light 184. Because the light 184 and light 181 have different emergent angle, the viewer can easily sense the lively saturate color 184 over a large viewing angle and sense the specula color 181 within a small viewing angle. In the present invention, two colors can be displayed in the same pixel depending on the viewing angle. In the normal ambient light condition, the light 184 is more preferable because of the viewing angle and the color density. As the light 181 has the same angle as the surface specula reflection, people always try to avoid this viewing direction subconsciously when they watch the display under the normal light condition. However, in the dark ambient light condition, the light 181 is valuable to the viewer. One of the two-color solution is that the color of light 181 is chosen as yellow and light 184 as deep blue. The other two-color solution is red for light 181 and greenish blue for light 184.

If the metal has a specula surface, it will reflect the light in a narrow angle which is determined by the reflection law. The complementary color 183 will pass through the display cell and becomes a specula light 184. Because the light 184 has the same emergent angle as the light 181 and the surface reflection, people always try to avoid this viewing direction subconsciously when they watch the display. So the display will take on a dark background over a large viewing angel in the planar area.

As the display addressed in a focal conic texture 112, the display works in the optical white state. When the incident light 180 reaches the display cell with focal conic texture 112, it will be scattered into milky-white color by the distribution of small, birefringence domains. The light 180 will split into two portions, a substantial portion of the incident light (90˜95%) being forward scattered 185 and the lesser portion (5˜10%) being back scattered 188. As the forward scattered light 185 hits on the composite structure of the back circular polarizer 160 and the reflector 170, 50% right-handed polarized light 186 will be reflected back, while the other 50% left-handed light is absorbed by the circular polarizer 160. The light 186 passes the display cell again and becomes depolarized light 187 due to the focal conic scattering effect. The emergent light 187 has a pure white color to the viewer. Moreover, the back-scattered light 188 in the focal conic texture area will directly reach to the viewer. The percentage of the back scattering to the total incoming light is depending on the cell thickness and the optical birefringence of the liquid crystal material.

Finally, there will be approximately 50% incoming light emergence from the display's focal conic area including the front scattered light 187 and back scattered light 188. The brightness of the display is equal to that of the newspaper. What different from the prior art is that the present invention takes the advantage of back scattering as well as the forward scattering effect of the focal conic texture. In the prior art, the back scattering is always treated as a negative factor because it is harmful to the contrast of the display.

One of the fundamental differences of the present invention to the prior art is the neutral white performance. The present invention doesn't utilize planar texture as the white state and related color composition technologies. Furthermore, there is no polarizer or other optical component in front of the cell structure, which used to distort the whiteness of the emergence light.

The other fundamental difference of the present invention to the prior art is that the superior whiteness due to the addition of the back scattering effect. The novelty delivers a paper-white appearance with 50% reflectivity.

In order to enhance the contrast ratio, an optimal design of the liquid crystal formulation is necessary. Increasing the Δn, the optical birefringence of liquid crystals can both enhance the back scattering in the focal conic texture area and the complementary color in the planar texture area. Normally, the Δn needs to be in the range of 0.2˜0.35, more preferably, 0.25˜0.3.

Above all, with the bright white state in focal conic area and the dark color state in planar area, the present invention achieves a newspaper white display with a dark color.

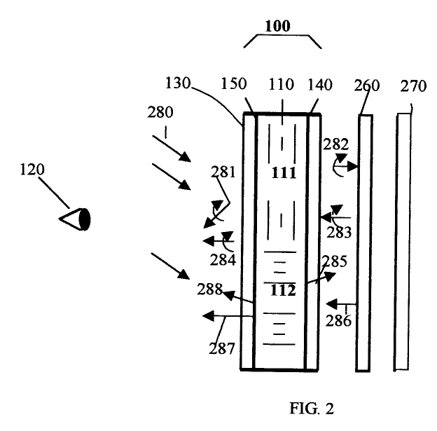

Turning now to FIG. 2, illustrated is a schematical display structure, wherein a reflective circular polarizer, attached onto the outside of the back substrate of the display cell, combined with a black painting layer.

A cell structure 100 includes a cholesteric liquid crystal material 110, a front substrate 130, a back substrate 140 and a polymeric ring material. The cell gap is controlled by a micro-beats with the diameter normally in the range of 2˜6 μm, most preferably, 3 μm. The front substrate and the back substrate are pre-coated a transparent thin film of conductive electrodes and a polyimide alignment layer on the inner surface, respectively. There are two stable cholesteric textures inside the cell structure; planar texture area 111 and focal conic texture area 112. Both are electrically controllable. There is a special single domain design in the present invention. The front alignment layer 150 has been rubbed to generate a substantially single domain structure in the cholesteric planar area while the back alignment can be either rubbed or non-rubbed. It is well known that the single domain planar texture has a mirror Bragg reflection. The display cell structure combined with a back reflective circular polarizer 260 and a black absorbing layer 270 to form a complete display panel. The back circular polarizer 260 is made of a cholesteric broadband polarizer. The handedness of the reflective circular polarizer is designed to be the same as the helical structure of the cholesteric liquid crystal, for example, right-hand for the convenience of description.

The working principle is almost the same as FIG. 1. When the natural light 280 reaches the ChLC film 110 in planar texture area 111 through the front substrate 130, part of it (right-handed and within the Bragg wave band) will be mirror reflected. The rest of it, including left-handed component and the remaining right-handed portion will hit on the reflective circular polarizer 260 through the area 111. The left-handed circular polarizing light will then pass through the reflective circular polarizer 260 and finally absorbed by the black film. The right-handed circular polarizing light 283 is reflected by the polarizer 260. One may notice that the light 283 is a complementary color of 281. For example, if the Bragg reflection 281 is designed to be yellow, the light 283 will be blue. Furthermore, the light 283 passes the planer area 111, and finally emerges to the display front surface as the right-handed circular polarization 284.

There are two different appearances to the front viewer 120 in the display planar area depending on the emergent direction and distribution of the light 283, which is determined by the pattern of the reflective circular polarizer.
1. Diffusively reflective circular polarizer
If the reflective circular polarizer adopted is a diffusive one, it will reflect the light in a large distribution angle. The complementary color 283 will pass through the display cell and becomes a diffusive light 284. Because the light 284 and light 281 have different emergent angle, the viewer can easily sense the lively saturate color 284. Since the light 281 has the same angle as the surface specula reflection, people always try to avoid this viewing direction subconsciously when they watch the display. If the color of light 281 is chosen as yellow, the 284 will be deep blue.
2. Specula reflective circular polarizer
If the polarizer adopted is a specula circular polarizer it, will reflect the light in a narrow angle which is determined by the reflection law. The complementary color 283 will pass through the display cell and becomes a specula light 284. Because the light 284 has the same emergent angle as the light 281 and as the surface reflection, people always try to avoid this direction subconsciously when they watch the display. So the display will take on a dark background over a large viewing angel in the planar area.

As the display addressed in a focal conic texture 112, the display works in the optical ON state. When the incident light 280 reaches the display cell with focal conic texture 112, it will be scattered into milky-white color. The light 280 will split into two portions, a substantial portion of the incident light (90˜95%) being forward scattered 285 and the lesser portion (5˜10%) being back scattered 288. As the forward scattered light 285 hits on the reflective circular polarizer 260, the portion of the right-handed polarized light 286 will be reflected back, while the portion of the left-handed light will be absorbed by the black layer 270. The light 186 passes the display cell again and becomes depolarized light 287 due to the focal conic scattering effect. The emergent light 287 has a pure white color to the viewer. Moreover, the back-scattered light 288 in the focal conic texture area will directly reach to the viewer. The percentage of the back scattering is depending on the cell thickness and the optical birefringence of the liquid crystal material.

Finally, there will be over 50% incoming light emergence from the display's focal conic area, including the front scattered light 287 and back scattered light 288. The brightness of the white state is equal to or better than that of the newspaper. What different from the prior art is that the present invention takes the advantage of back scattering as well as the forward scattering effect in the focal conic texture. In the prior art, the back scattering is always a negative factor and being thought harmful to the contrast of the display.

Above all, with the bright white state in focal conic area and the dark color state in planar area, the present invention achieves a paper white display on a dark background.

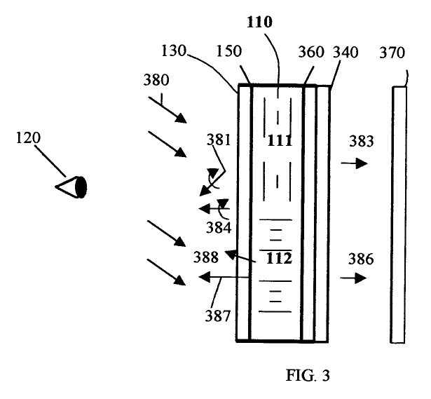

Turning now to FIG.3, illustrated is a schematical display structure, wherein a reflective circular polarizer, attached onto the inside of the back substrate of a display cell, combined with a outside black painting layer.

The manufacture of the back substrate is described as follows. Firstly, the inside surface of the glass panel 340 is coated by a UV curable cholesteric material with the thickness of 20 μm which is polymerized under a suitable condition and duration. Secondly, an over coating (OC) material is spin-coated on the top of the broadband cholesteric layer with the thickness of 17 μm and is thermo-cured completely. Fourthly, an ITO transparent conductive layer is sputtered on the top of the OC layer with the thickness of 0.18 μm. Finally, a chemical wet imaging process is carried out. A black coating layer or an equivalent back housing structure 370 is attached on the back of the substrate.

The working principle is almost the same as FIG. 2. When the natural light 380 reaches the cholesteric film 110 in planar texture area 111 through the front substrate 130, part of it (right-handed and within the Bragg wave band) will be mirror reflected. The rest of it, including left-handed component and the remaining right-handed portion will hit on the reflective circular polarizer 360 through the area 111. The left-handed circular polarizing light will then pass through the reflective circular polarizer 360 and finally absorbed by the black film. The right-handed circular polarizing light which is reflected by the polarizer 360 passes the planer area 111 and finally emerges to the display front surface as the right-handed circular polarization 384.

There are two different appearances to the front viewer 120 in the display planar area depending on the emergent direction and distribution of the light 184, which is determined by the pattern of the reflective circular polarizer.
1. Diffusively reflective circular polarizer
If the reflective circular polarizer adopted is a diffusive one, it will reflect the light in a large distribution angle. The complementary color 383 will pass through the display cell and becomes a diffusive light 384. Because the light 384 and light 381 have different emergent angle, the viewer can easily sense the lively saturate color 384. Since the light 381 has the same angle as the surface specula reflection, people always try to avoid this viewing direction subconsciously when they watch the display. If the color of light 381 is chosen as yellow, the 384 will be deep blue.
2. Specula reflective circular polarizer
If the polarizer adopted is a specula circular polarizer, it will reflect the light in a narrow angle which is determined by the reflection law. The complementary color 383 will pass through the display cell and becomes a specula light 384. Because the light 384 has the same emergent angle as the light 381 and as the surface reflection, people always try to avoid this direction subconsciously when they watch the display. So the display will take on a dark background over a large viewing angel in the planar area.

As the display addressed in a focal conic texture 112, the display works in the optical ON state. When the incident light 380 reaches the display cell with focal conic texture 112, it will be scattered into milky-white color by a distribution of small, birefringence domains. The light 380 will split into two portions, a substantial portion of the incident light (90˜95%) being forward scattered and the lesser portion (5˜10%) being back scattered 388. As the forward scattered light hits on the reflective circular polarizer 360, the portion of the right-handed polarized light will be reflected back, while the portion of the left-handed light will be absorbed by the black layer 370. The reflected light passes the display cell again and becomes depolarized light 387 due to the focal conic scattering effect. The emergent light 387 has a pure white color to the viewer. Moreover, the back- scattered light 388 in the focal conic texture area will directly reach to the viewer. The percentage of the back scattering is depending on the cell thickness and the optical birefringence of the liquid crystal material.

Finally, there will be over 50% incoming light emergence from the display's focal conic area, including the front scattered light 387 and back scattered light 388. The brightness of the display ON state is better than that of the newspaper. What is different from the prior art is that the present invention takes the advantage of back scattering effect as well as the forward scattering effect in the focal conic texture. In the prior art, however, the back scattering is always a negative factor and harmful to the contrast of the display.

One of the fundamental differences of the present invention to the prior art is the neutral white performance. The present invention doesn't utilize the planar texture as the white state and related color composition technologies. Furthermore, there is no polarizer or other optical component being positioned in front of the cell structure that jeopardizes the transmission of the emergence light.

The other fundamental difference of those state of the art to the prior art is that the superior whiteness due to the addition of the back scattering effect. The present invention delivers a paper-white appearance with 50% reflectivity.

Above all, with the white state in focal conic area and the dark color state in planar area, the present invention achieves a paper white display on the dark background.

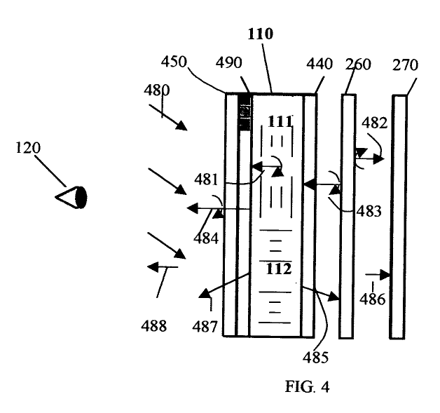

Turning now to FIG.4, illustrated is a front color filter positioned inside of the display cell.

A color filter layer 490, including red, green and blue patterning, is deposited on the front substrate 430. The Bragg reflection out of 110 will be substantially cut off by the front color filter 490, due to the fact that the wave band of the Bragg reflection is designed on purpose in non-primary color band, for example, yellow color with the wavelength of 580 nm.

When the natural light 480 passes through the front color filter layer 490, it will be attenuated initially by the absorptive coloring material. The remaining portion will then reach the cholesteric film 110 in planar texture area 111, part of it (right-handed and within the Bragg wave band), light 481 will be mirror reflected and further absorbed by the color filter structure. The rest of it, including left-handed component and the remaining right-handed portion will hit on the reflective circular polarizer 260 through the area 111. The left-handed circular polarizing light 482 will then pass through the reflective circular polarizer 260 and finally be absorbed by the black film, while the right-handed circular polarizing light 483 will be reflected by the polarizer 260. One may notice that the light 483 is a complementary color of 181. For example, if the Bragg reflection 481 is designed to be yellow, the light 483 will be blue. Furthermore, the light 483 passes the planer area 111, and once more being absorbed by the front color filter layer and finally emerges to the display front surface as the right-handed circular polarization 484. Due to the multi-path absorptions, the light 484 is only a small percentage of the incoming light and it takes on a black dark with a little color tint.

As the display addressed in a focal conic texture 112, the display works in the full color state. When the portion of the incident light 480 reaches the display cell with focal conic texture 112 through the color filter layer where a portion of the light 480 being attenuated, the remaining light will be scattered into milky-white color by a distribution of small, birefringence domains. The remaining light will split into two parts, a substantial portion of the incident light (90˜95%) being forward scattered 485 and the lesser portion (5˜10%) being back scattered (see light 488). As the forward scattered light 485 hits on the reflective circular polarizer 260, the portion of the right-handed polarized light will be reflected, while the portion of the left-handed light 486 will be absorbed by the black layer 270. The light passes the display cell again and becomes depolarized light due to the focal conic scattering effect. The emergent light 487 and 488 are colored light which is predetermined by the color filter.

Above all, with the full color state in focal conic area and the dark state in planar area, the present invention achieves a full color reflective display.

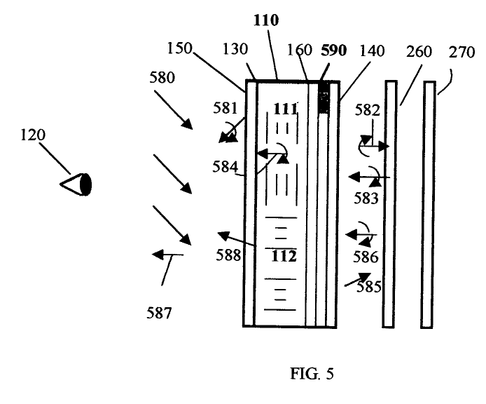

Turning now to FIG. 5 illustrated is a sectional drawing of a display structure, wherein a color filter layer is positioned on the back substrate of a display cell structure.

The working principle is almost the same as FIG. 4. When the natural light 580 reaches the cholesteric film 110 in planar texture area 111 through the front substrate 130, part of it (right-handed and within the Bragg wave band) will be mirror reflected (see light 581). The rest of it, including left-handed component and the remaining right-handed portion will pass through the internal color filter layer 590 where being partially attenuated. The remaining portion of the light will hit on the reflective circular polarizer 260 through the area 111. The left-handed remaining light will then pass through the reflective circular polarizer 260 and finally be absorbed by the black film 270. The right-handed circular polarizing light 583 reflected by the polarizer 260 passes the planer area 111 and finally emerges to the display front surface as the right-handed circular polarization 584.

There are two different appearances to the front viewer 120 in the display planar area depending on the emergent direction and distribution of the light 584 which is determined by the pattern of the reflective circular polarizer.

The specula reflective circular polarizer adopted will reflect the light in a narrow angle which is determined by the reflection law. The complementary color 583 will pass through the display cell and becomes a specula light 584. Because the light 584 has the same emergent angle as the light 581 and as the surface reflection, people always try to avoid this direction subconsciously when they watch the display. So the display will take on a dark background over a large viewing angel in the planar area.

As the display addressed in a focal conic texture 112, the display works in the full color state. When the incident light 580 reaches the display cell with focal conic texture 112, it will be scattered into milky-white color by a distribution of small, birefringence domains. The light 580 will split into two portions, a substantial portion of the incident light (90˜95%) being forward scattered and the lesser portion (5˜10%) being back scattered 588. As the forward scattered light passing through the color filter layer, it will be selectively absorbed by the color filter array. The remaining light will then hit on the reflective circular polarizer 260, the portion of the right-handed polarized light will be reflected, while the portion of the left-handed light will be absorbed by the black layer 270. The reflected light passes the color filter as well as the display cell again and becomes colored depolarized light due to the focal conic scattering effect. The emergent light 587 has a color or a color reproduction to the viewer. One may notice that, the back-scattered light 588 in the focal conic texture area will directly reach the viewer. The percentage of the back scattering is depending on the cell thickness and the optical birefringence of the liquid crystal material.

Above all, with the full color state in focal conic area and the dark state in planar area, the present invention achieves a full color reflective display with a dark color. The advantage of this display structure is the white color brightness. Compared with the FIG.4, the display looks whiter and brighter but the full color image will be dilute by the back scattering to a certain extent. Whiteness is indeed an important parameter of the reflective display. However, in case of the color purity or color saturation is required, the front color filter structure as depicted in FIG. 4 is preferred.

1. A reflective display comprising:
a. a circular polarizer,
b. a diffusive reflector,
c. a plurality of transparent conductive patterned substrates juxtaposed to form a cell structure with a predetermined inner surface condition,
d. a cholesterics material with
i. a specula color of Bragg reflection out of controllable planar texture, and
ii. a diffusive complementary color of Bragg reflection out of controllable planar texture, and
iii. a backward scattered light out of controllable focal conic texture, and
iv. a forward scattered light out of controllable focal conic texture,
wherein the cell structure enclosing the cholesteric material within inner surfaces, attaching the circular polarizer on the back outer surface and the metal reflector at the utmost back side of the structure, and exposing the front outer surface directly to a viewer, wherein the specula color of Bragg reflection and the diffusive complementary color have a different reflecting angle, while the backward scattered light and the forward scattered light are traveling to the front of the cell structure, whereby at least one color will be displayed in the controllable planar texture area, and a bright white color will be displayed in the controllable focal conic texture area.

2. The reflective display as in claim 1 wherein the circular polarizer is an absorptive circular polarizer with its retarder side contacting the cell structure.

3. The reflective display as in claim 1 wherein the diffusive reflector is a metal reflector.

4. The reflective display as in claim 1 wherein the predetermined inner surface condition means that at least the front inner surface has a rubbed parallel alignment layer.

5. The reflective display as in claim 1 wherein the specula color of Bragg reflection has a narrow viewing angle in the range of 0˜30 degree.

6. The reflective display as in claim 1 wherein the complementary color of Bragg reflection has a substantially hemispheric viewing angle, excluding the viewing angle of Bragg reflection.

7. The reflective display as in claim 1 wherein the bright white color is a pure white color.

8. The reflective display as in claim 1 wherein the reflective display is a color on white display.

9. The reflective display as in claim 1 wherein the specula color of Bragg reflection is preferably viewed in a dark ambient light condition.

10. The reflective display as in claim 1 wherein the complementary color of Bragg reflection is preferably viewed in a normal ambient light condition.

11. A reflective display comprising:
a. a reflective circular polarizer
b. a plurality of transparent conductive patterned substrates juxtaposed to form a cell structure, and
e. a cholesterics material with
v. a specula color of Bragg reflection out of controllable planar texture, and
vi. a complementary color of Bragg reflection out of controllable planar texture, and
vii. a backward scattered light out of controllable focal conic texture, and
viii. a forward scattered light out of controllable focal conic texture,
wherein the cell structure enclosing the cholesteric material within inner surfaces, attaching the reflective circular polarizer on the back surface, and exposing the front outer surface directly to a viewer, wherein the specula color of Bragg reflection and the complementary color travel a different direction, while the backward scattered light and the forward scattered light are traveling to the front of the structure, whereby at least one color will be displayed in the controllable planar texture area, and a bright white color will be displayed in the controllable focal conic texture area.

12. The reflective display as in claim 11 wherein the reflective circular polarizer is a specula cholesteric polymer circular polarizer.

13. The reflective display as in claim 11 wherein the predetermined inner surface condition means at least the front inner surface has a rubbed alignment layer.

14. The reflective display as in claim 11 wherein the specula color of Bragg reflection has a narrow viewing angle in the range of 0˜30 degree.

15. The reflective display as in claim 11 wherein the complementary color of Bragg reflection is substantially traveling to the backside of the display.

16. The reflective display as in claim 11 wherein the bright white color is a pure white color.

17. The reflective display as in claim 11 wherein the reflective display is a dark color on white display.

18. The reflective display as in claim 11 further including a color filter layer positioned inside of the display cell structure and in front of the reflective circular polarizer to achieve a reflective full color display.

19. The reflective display as in claim 18 wherein the color filter is positioned in such a way that it substantially absorbs the specula color of Bragg reflection.

20. The reflective display as in claim 18 wherein the reflective full color display has a substantial hemispherical viewing angle.
